(19) United States
(12) Patent Application Publication
(10) Pub. No.: US 2009/0025020 A1
(43) Pub. Date: Jan. 22, 2009

(54) Optical disc loader for recorders with integrated labeling facility

(76) Inventor: Rolf D. Kahle, Saratoga, CA (US)

Correspondence Address: Terry McHugh;Law Offices of Terry McHugh, 101 First Street - PMB 560, Los Altos, CA, 94022, US

(21) Appl. No.: 12/218,677

(22) Filed: Jul. 17, 2008

Related U.S. Application Data
(60) Provisional application No. 60/961,005, filed on Jul. 18, 2007.

(51) Int. Cl. G11B 17/03

(52) U.S. Cl. 720/615; G9B/17.009

(57) ABSTRACT

In accordance with the invention, an automatic disc loader and unloader is integrated into an optical disc recorder having a labeling facility. In one embodiment, a supply stack of discs is positioned generally directly above an extended delivery tray of the system. Thus, a relatively small footprint is required. Also in the preferred embodiment, a disc take-up facility is located below the extended tray, so as not to extend substantially beyond the recorder/labeler with the tray in its extended condition. The loading of discs into the tray and the unloading of discs from the tray may be accomplished by a coordinated mechanism driven by a single motor.

### CROSS REFERENCE TO RELATED APPLICATION

This application claims priority from co-pending provisional application No. 60/961,005, filed Jul. 18, 2007.

### TECHNICAL FIELD

The invention relates generally to processing systems for optical discs and more particularly to automated systems for recording data and printing data on optical discs.

### BACKGROUND ART

It is common to store machine-readable data on an optical disc, such as a compact disc (CD) or digital video disc (DVD). Movies, music libraries, digital images, and computer software are some examples of the types of data which are stored on optical discs by originators and end users of the data.

In some situations, identical data is recorded on a significant number of optical discs. For DVDs, the machine-readable information may be a movie which is about to be released for DVD distribution. Similarly, a large number of CDs may be recorded with the music of a particular artist for mass distribution.

In addition to the machine-readable data, optical discs often include human-readable data that identifies the content of the stored information. The human-readable data is conventionally on the opposite side of the optical disc as the machine-readable data. This human-readable information may be considered as a “label.” Labels may be applied by adhesive or using thermal transfer techniques. As another possibility, the label information may be printed directly on the optical disc. Inkjet printing is one option.

A common process in entering identical data onto a number of optical discs is to sequentially move discs from a supply stack to a recorder for “burning” the information to be stored, then to a labeling device, and finally collecting the completed discs for subsequent packaging. For example, U.S. Pat. No. 7,063,746 to Russ describes a writing and marking system that includes a duplication station which receives discs from a dispenser and writes the data onto the discs before a conveyor belt moves each disc past a marking device which places indicia on the disc. Enhanced efficiency of the processing is described in U.S. Pat. No. 7,172,991 to Anderson et al. This patent states that laser-sensitive materials may be formed on the side of an optical disc opposite to the read/write surface, so that a laser may be used to record the human-readable indicia by merely inducing visible light change within the laser-sensitive materials. As a result, the recording and the labeling can occur without relocation of an optical disc. Disc copying and labeling at a single location is also described in U.S. Pat. No. 7,061,515 to Cummins et al. and U.S. Pat. No. 6,264,295 to Bradshaw et al.

While current systems for processing optical discs operate well for their intended purposes, additional enhancements in automated processing techniques are sought, particularly where the enhancements are available without significantly increasing the “footprint” area required for the system.

### SUMMARY OF THE INVENTION

An optical disc processing system in accordance with the invention includes an automated loader/unloader that includes a feed mechanism for automatically singulating a lowermost disc from a disc stacker for delivery to a data recorder in which machine-readable data is recorded and human-readable data is printed without requiring disc relocation between the recording operation and the printing operation. The disc stacker is dimensioned to hold a supply stack such that the lowermost disc in the stack is above the start position for a delivery facility that defines the disc transport path of the data recorder. In the preferred embodiment, this delivery facility includes a delivery tray that is mounted to move linearly between the start position in which discs are supplied and released and the record/label position at which the recording and print operations occur. However, as an alternative to the use of a delivery tray, the delivery facility of the data recorder may be a slot feed mechanism.

For embodiments in which the delivery facility includes a delivery tray, the axis of the supply stack of discs within the disc stacker is preferably aligned with or only slightly offset from the axis of the disc seating configuration of the delivery tray when the tray is in its extended condition. Thus, the footprint of the system is only slightly greater than the footprint of the data recorder with the delivery tray in the extended condition. Also in the preferred embodiment, the take-up facility of the system does not substantially affect this required footprint. This is possible by establishing the area below the disc stacker as the collection area for the processed optical discs. Thus, if the delivery facility includes a tray, the system may include programming that dictates a sequence of actions as follows: extend the delivery tray, singulate the lowermost disc from the stack so as to lower onto the extended tray, retract the tray, record and print data onto the disc, extend the tray, lift the process disc from the tray, retract the tray, drop the processed disc to the take-up facility, and repeat.

In one preferred embodiment of the invention, the feed mechanism accesses the discs within the disc stacker such that a loading sequence includes a gravity feed of the lowermost disc. The feed mechanism may be configured to release a first circumferential region of the lowermost disc onto the delivery tray prior to releasing the circumferential region opposite to the first. The loader/unloader may be driven by a single motor. For example, the apparatus may include a pair of arms mounted for movement in opposite directions, so as to enable manipulation of the optical disc. Each arm may include a stop plate that is positioned to contact the optical disc, with the stop plates being tilted from the horizontal in order to reduce the likelihood of contact with the printed human-readable data. A cam body may be controlled by the single motor, with the cam body controlling operations of a pair of cam followers that in turn control movement of the arms. The motor-driven cam body may have a one-dimensional profile which is operable for disc loading operations and have a two-dimensional profile which is operable for disc unloading operations. Relative to a home position, the motor-driven cam body may have a mid-revolution stop position which removes the arm from interference with movement of the delivery tray.

### BRIEF DESCRIPTION OF THE DRAWINGS

FIG. 1 is a perspective view of an optical disc processing system with integrated labeling and automated disc loading and unloading in accordance with the invention.

FIG. 2 is an illustration of one embodiment of singulating a lowermost disc from a supply of discs for loading a delivery mechanism, such as a tray.

FIG. 3 is a top view of the singulation and loading mechanism of FIG. 2.

FIG. 4 is a top view of a cam drive to actuate the movable parts of the mechanism of FIG. 3.

FIGS. 5A-5D illustrate the sequence for disc unloading.

FIG. 6 is a top view of the cam-driven mechanism to accomplish the disc unloading of FIG. 5.

FIG. 7 is a block diagram of functional components of an optical disc processing system in accordance with the invention.

### DETAILED DESCRIPTION

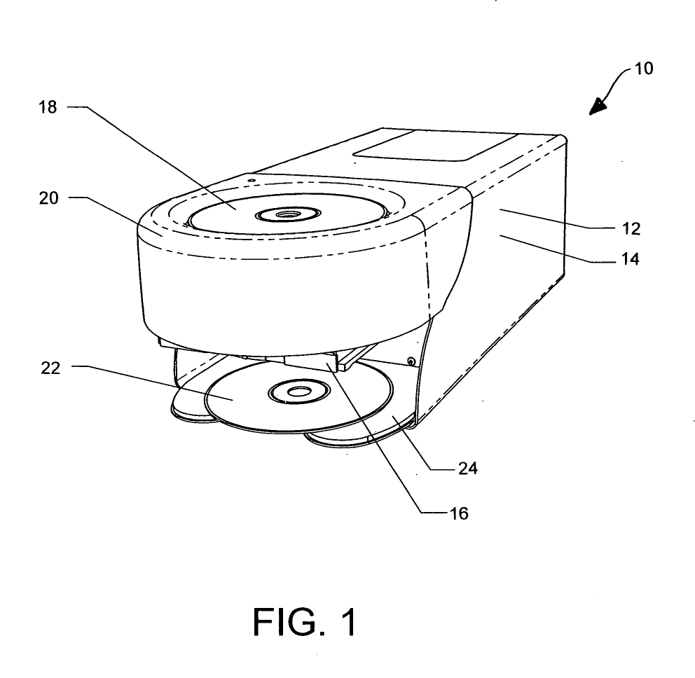

With reference to FIG. 1, one embodiment of a disc processing system 10 in accordance with the invention is shown. While not visible, the system includes a data recorder 12 below a labeling device 14. The data recorder is positioned to record machine-readable data onto an optical disc, such as a CD or DVD. The labeling device is positioned to print human-readable data (labeling information) onto the optical disc while the disc remains in the same position. In one embodiment, the labeling device uses inkjet printing techniques, but other operations may be used without diverging from the present invention. The data recorder and labeling device are integrated into one assembly with an automated disc loader/unloader, as will be explained more fully below.

A delivery tray is shown in an extended condition within FIG. 1. In the extended condition, the delivery tray resides below a supply stack 18 of discs. A disc stacker 20 is dimensioned to hold the discs in position, such that the lowermost disc in the stack is located for feeding into the delivery tray 16 when in its extended condition. The disc stacker may have a capacity of between 25 and 100 discs, but this is not critical. Also shown in FIG. 1 is a processed disc 22 resting in the take-up compartment 24 of the processing system 10. The disc 22 is “processed,” since it has undergone operations by the disc recorder 12 and the labeling device 14.

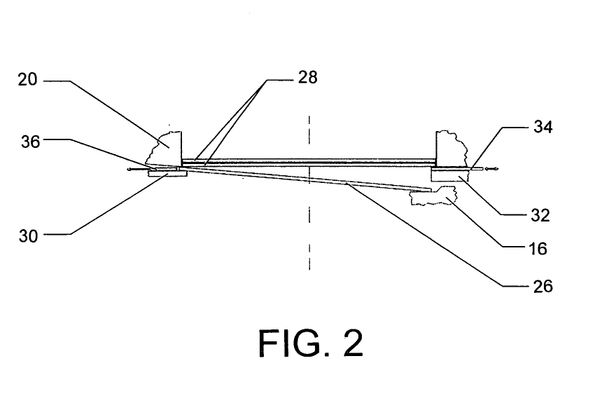

FIG. 2 illustrates one embodiment of the principle for singulating a lowermost disc from the supply stack of discs. Specifically, a lowermost disc 26 is separated from the remaining discs 28. As shown in FIG. 2, initially one circumferential region of the lowermost disc 26 is allowed to drop onto the disc seating portion of the delivery tray 16. The disc stacker may be a circular containment device having shelves 30 and 32 that provide stationary disc supports. When the lowermost disc is pushed by a gate 34, the edge of the lowermost disc falls from the corresponding shelf 32 and comes to rest on the delivery tray 16. In order to complete the disc loading procedure, a pusher 36 moves to the right as viewed in FIG. 2 in order to remove the opposite edge of the lowermost disc from the shelf 30. The supply stack of discs 28 is positioned with respect to the extended tray in a way that the lowermost disc falls exactly into the cavity provided by the delivery tray. A very short distance between the stack and the tray ensures a predictable fall of the lowermost disc.

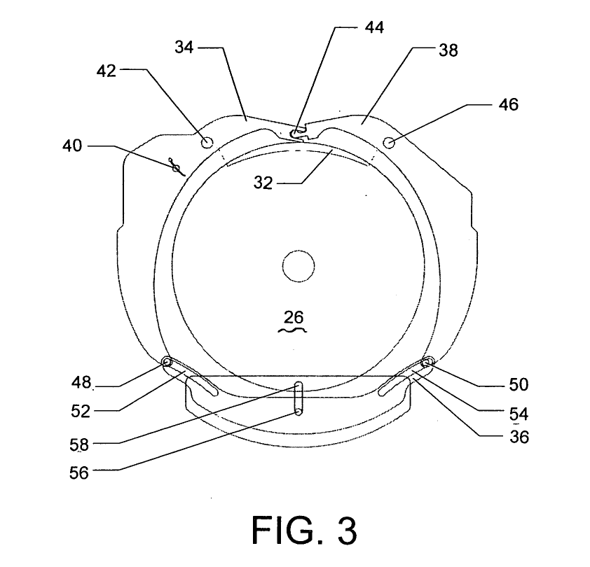

FIG. 3 shows a top view of a more detailed implementation of the singulation and loading mechanism. The gate 34 that was described with reference to FIG. 2 is accompanied by a second gate 38. The two gates 34 and 38, as well as the pusher 36, are shown in the home positions before singulation starts. These home positions also apply to the end of a singulation process. In the home positions, the disc stack rests on nearly a complete rim circle provided by the gates, the shelf 32, and the pusher 36. As a consequence, reloading of discs can occur without concern that the discs will fall sideways through the opening at the bottom of the disc stacker.

A singulation and loading cycle begins with opening of the two gates 34 and 38, and completes with the reclosing of the gates. A cam follower pin 40 is attached to the first gate 34, such that movement of the cam follower pin causes the gate to pivot about pivot point 42. A coupling 44 between the two gates causes the second gate to pivot symmetrically about pivot point 46. Regarding the movement of the pusher 36, the pusher is actuated by a pair of pins 48 and 50 at the ends of the two gates 34 and 38, respectively. These pins at the ends of the gates ride within slots 52 and 54 formed within the pusher 36. The slope and the curvature of the slots are selected to achieve the desired movement of the pusher. In comparison to the two moving pins 48 and 50, a third pin 56 is stationary. This stationary third pin restricts the pusher from tilting, since it extends within a slot 58 of the pusher.

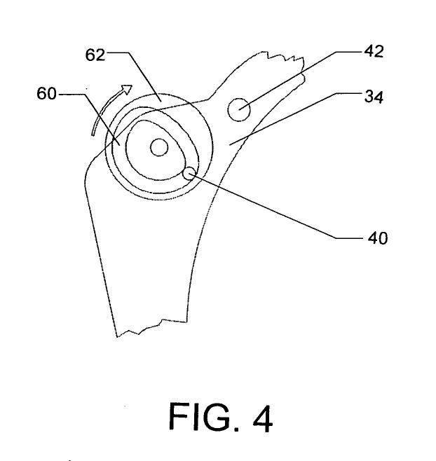

FIG. 4 is a further illustration of the mechanical interactions. Only the first gate 34 is shown. As noted above, the gate is attached to the cam follower pin 50 such that movement of the pin causes rotation of the gate about the pivot point 42. The cam follower pin runs within a groove 60 of a cam 62. Rotation of the cam 180° clockwise from the position depicted in FIG. 4 completes a cycle of opening and closing the gate, and therefore a complete singulation and load procedure of the lowermost disc. The cam is therefore stopped after the 180° clockwise rotation. Referring to FIGS. 3 and 4, the rotation of the gate 34 about the pivot point 42 drives the second gate 38 as a result of the coupling 44. Then, the movement of the two gates is translated to operation of the pusher 36 as a result of the pins 48 and 50 moving within the slots 52 and 54.

With the cam 62 stopped following the 180° rotation, the lowermost disc 26 is loaded into the delivery tray 16. Thus, the tray may be retracted to place the disc in its record/label position for entering the machine-readable data and the human-readable data. When the process is finished, the tray may be returned to its extended condition for unloading the disc. Rotation of the cam from its 180° position to the 360° position operates the disc unload procedure and returns the cam to the home position, ready for a next singulation and load process.

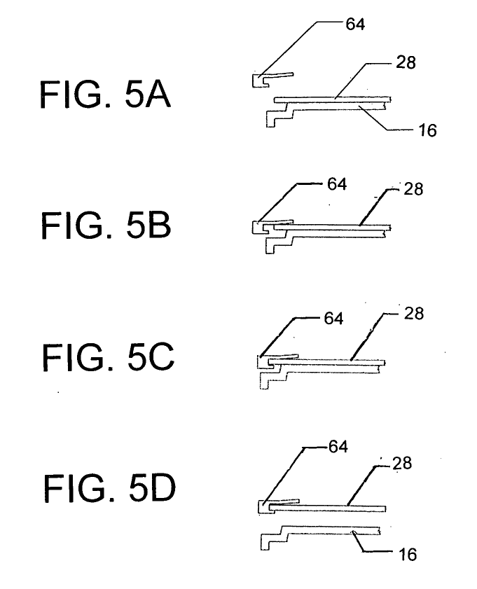

FIGS. 5A, 5B, 5C and 5D illustrate the sequence of steps of a disc unloading operation. However, only one of the two arms is shown. The arm 64 is used to grasp, lift and then drop one side of the disc 28 which initially rests on the delivery tray 16. In FIG. 5A, the arm is shown in its home position, removed from any interference with loading discs onto the delivery tray and any interference with movement of the delivery tray between its extended condition and its retracted condition. At the start of an unload procedure, the arm 64 moves both downwardly and toward the center of the disc 28, until the arm rests on the disc, as shown in FIG. 5B. This is the disc-finding position. The upper portion of the arm is slanted in order to restrict contact with the rim of the disc, so as to avoid any contact with fresh ink that was applied during the labeling process. The upper part of the arm is also sufficiently wide to accommodate disc location tolerances.

In the position shown in FIG. 5C, the disc 28 is shown as being grasped by the arm 64. Then, in FIG. 5D, the disc 28 has been lifted from contact with the tray 16. The arm movements from FIG. 5A to 5D are continuous, but the arms then stop to allow the now empty delivery tray 16 to be retracted. Then, with the tray no longer interfering with the drop of the disc 28, arm movement returns to the position shown in FIG. 5A (i.e., the home position). This allows the disc to drop into the take-up compartment 24 shown in FIG. 1.

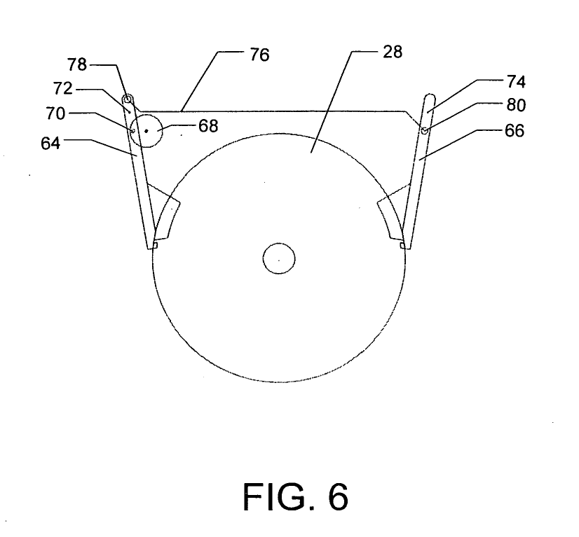

FIG. 6 shows one implementation of a mechanism to operate the two arms 64 and 66 which grasp the disc 28 in the manner described with reference to FIGS. 5A-5D. However, other embodiments may be used without diverging from the claimed invention. The illustrated design was selected because of its minimal space requirements and minimal number of required parts. A cam 68 has a horizontal and vertical profile to operate on a follower pin 70 that is attached to the arm 64. The cam 68 is a portion of a composite cam 62 that was described with reference to FIG. 4 as serving the disc singulation and load function. Because the disc singulation and load function and the disc unload function are exclusive, the respective cam profiles may be located on selected sections of the composite cam. This single composite cam is driven by a single motor. A timing disc attached to the cam and a sensor may be used to allow stopping of the motor at three significant points during one cam revolution: home/start load position, completed load/start unload position, completed lifting disc from tray/ready for tray retraction, and back at home/start load position.

In FIG. 6, the arm 64 is confined vertically, but is free to pivot horizontally at point 72. Similarly, the arm 66 is free to pivot at point 74. A rigid link 76 is hinged to both arms by means of vertical bearings 78 and 80. Consequently, as the first arm 64 is caused to move by rotation of the cam 68, the second arm 66 follows in a symmetrical fashion. That is, the two arms will cooperate in grasping different regions along the circumference of the disc 28 or will move apart in order to release the disc.

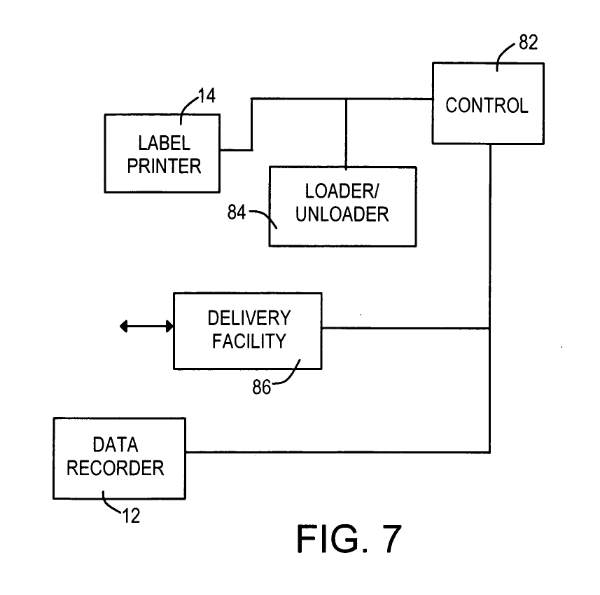

Referring now to FIGS. 1 and 7, a control component 82 determines operations of the data recorder 12 and the label printer 14. The control component may be a single microprocessor or may be a cooperative arrangement of various subcomponents. The control component also includes programming which determines the timing of the loader/unloader 84 and the delivery facility 86. Where the delivery facility includes a tray as described above, the timing is carefully controlled to ensure reliability and efficiency.

In operation, a supply stack 18 is provided and a load operation is initiated. This requires that the delivery tray 16 be moved to the extended condition shown in FIG. 1. Then, the lowermost disc of the supply stack is released. The delivery tray is retracted to position the disc for the recording and labeling operations. Upon completion, the delivery tray is returned to its extended condition by the control component 82 of FIG. 7.

In a next step, the processed optical disc is removed from the delivery tray 16. This may be accomplished using the pair of arms 64 and 66 shown in FIG. 6, but other embodiments have been contemplated. With the processed disc in a raised position, the delivery tray is again retracted, clearing the path for release of the disc by the loader/unloader. The processed disc 22 of FIG. 1 is shown in the take-up compartment 24 of the system 10. Preferably, a chute is included. With the processed disc in the take-up compartment, the system is available to move the next disc from the supply stack 18 into the delivery tray 16. The process is repeated until a sufficient number of optical discs have been properly recorded and labeled.

What claimed is:

1. An optical disc processing system comprising:
a data recorder having an integrated labeling facility and a delivery facility, said data recorder being positioned to record machine-readable data onto an optical disc that is located at a record/label position, said labeling facility being positioned to print human-readable data onto said optical disc located at said record/label position, said delivery facility defining a disc transport path which discs must follow in movement between said record/label position and a second position in which discs are supplied and released;
a disc stacker dimensioned to hold a stack of said optical discs, said disc stacker being positioned such that a lowermost disc in said stack is above said second position; and
a disc loader/unloader for automated loading and unloading of said optical discs to and from said delivery facility, said disc loader/unloader including a feed mechanism operatively associated with said disc stacker to automatically singulate said discs in said stack and move said lowermost disc to said second position for manipulation by said delivery facility along said disc transport path.

2. The system of claim 1 wherein said delivery facility includes a delivery tray mounted to move linearly between said second position and said record/label position, said delivery tray having an extended condition in which said second position is below said lowermost disc within said disc stacker, such that a footprint of said system is generally that of said data recorder with said delivery tray in said extended condition.

3. The system of claim 2 wherein said disc loader/unloader further includes a take-up facility disposed to receive processed said optical discs below said disc stacker and below said delivery tray when said delivery tray is in said extended condition, such that said footprint remains generally that of said data recorder with said delivery tray in said extended condition.

4. The system of claim 3 wherein said take-up facility includes a chute configured to receive said discs.

5. The system of claim 3 further comprising programming configured to control said delivery tray to execute sequential steps which include (1) locating a first said optical disc in said record/label position during operations of recording said machine-readable data and printing said human-readable data, (2) relocating to said extended condition for extraction of said first optical disc from said delivery tray, (3) return to said record/label position to enable clearance of said first optical disc to a position below said disc stacker, and (4) return to said extended condition to receive said lowermost disc in said stack.

6. The system of claim 3 wherein said disc loader/unloader includes a singulation mechanism operatively associated with said disc stacker such that a loading sequence includes a gravity feed of said lowermost disc onto said delivery tray.

7. The system of claim 6 wherein said singulation mechanism is configured to release a first circumferential region of said lowermost disc prior to a second circumferential region opposite to said first.

8. The system of claim 1 wherein said disc loader/unloader is driven by a single motor.

9. The system of claim 1 wherein said disc loader/unloader includes a pair of arms mounted for movement in opposed directions to enable manipulation of said optical discs.

10. The system of claim 9 wherein each said arm includes a stop plate positioned to contact said optical discs, said stop plates being tilted from the horizontal to reduce likelihood of contact with said printed human-readable data.

11. The system of claim 9 wherein said disc loader/unloader further includes a pair of cam followers controlled by a single motor-driven cam body, with a one-dimensional profile which is operable for disc loading operations and with a two-dimensional profile which is operable for disc unloading operations.

12. The system of claim 11 wherein said motor-driven cam body has a home position and has a mid-revolution stop position that removes said arms from interference with movement of said optical discs along said disc transport path.

13. An optical disc processing system comprising:
a data recorder for recording data on an optical disc located at a record/label position;
a label printer for entering labeling information on said optical disc while located at said record/label position;
a delivery tray having a disc seat for holding said optical disc, said delivery tray having a retracted condition in which said optical disc resides at said record/label position and having an extended condition that enables removal of said optical disc;
a disc stacker dimensioned and positioned to hold a supply stack of optical discs such that a lowermost said optical disc is above said delivery tray when in said extended condition;
a take-up area receiving said optical discs following operations by said data recorder and label printer, said take-up area being below said delivery tray when in said extended condition; and
an automated loader/unloader operatively associated with said delivery tray and said disc stacker to selectively remove said optical discs from said disc seat and to feed said lowermost disc of said supply stack onto said disc seat.

14. The system of claim 13 wherein said automated loader/unloader is driven by a single motor and includes a pair of arms which move relative to each other to group said optical discs from said disc seat.
